(19) United States
(12) Patent Application Publication
(10) Pub. No.: US 2011/0065842 A1
(43) Pub. Date: Mar. 17, 2011

(54) METHOD FOR PRODUCING COMPOSITE FIBER MATERIALS

(75) Inventors: Stephan Weinkoetz, Neustadt (DE); Tilo Habicher, Speyer (DE)

(73) Assignee: BASF SE, Ludwigshafen (DE)

(21) Appl. No.: 12/675,032

(22) PCT Filed: Aug. 21, 2008
(86) PCT No.: PCT/EP2008/060916

§ 371 Date: Feb. 24, 2010

(30) Foreign Application Priority Data
Aug. 24, 2007 (EP) 07114909.0

(51) Int. Cl. C08L 89/00

(52) U.S. Cl. 524/17

(57) ABSTRACT

The invention relates to a process for producing fiber materials in which at least one hydrolytic protein mixture and at least one polyamine- or polyimine-containing binder or any desired mixture of these binders are used for producing the fiber materials. The invention furthermore relates to the use of at least one hydrolytic protein mixture and at least one polyamine- or polyimine-containing binder or any desired mixture of these binders alone or in combination with at least one other binder or at least one assistant or at least one other binder and at least one assistant for producing fiber materials.

The invention also relates to fiber materials which are obtainable by means of a process in which at least one hydrolytic protein mixture and at least one polyamine binder or at least one polyimine binder or at least one polyamine-containing or polyimine-containing binder or any desired mixture of these binders were used for producing the fiber materials.

The invention relates to a process for producing fiber materials in which at least one hydrolytic protein mixture and at least one polyamine- or polyimine-containing binder or any desired mixture of these binders are used for producing the fiber materials.

The invention furthermore relates to the use of at least one hydrolytic protein mixture and at least one polyamine- or polyimine-containing binder or any desired mixture of these binders alone or in combination with at least one other binder or at least one assistant or at least one other binder and at least one assistant for producing fiber materials.

The invention also relates to fiber materials which are obtainable by means of a process in which at least one hydrolytic protein mixture and at least one polyamine binder or at least one polyimine binder or at least one polyamine-containing or polyimine-containing binder or any desired mixture of these binders were used for producing the fiber materials.

Fiber materials are materials which are composed of small units of cellulose-containing plant material. These small units are designated as fiber and can be produced from numerous cellulose fibers or materials comprising lignocellulose. With the use of high pressure, heat or binders, the fiber is shaped into new materials, the so-called fiber materials, and bound again. If the fiber is pressed during the production of the fiber materials, different fiber materials having different densities can be produced, depending on the pressure used. At a density in the range from about 200 to about 400 kg/m³, the fiber materials are generally referred to as insulating boards; at a density of from about 350 to about 800 kg/m³, as a rule the term medium-hard fiber boards is used; at a density of from about 650 to about 900 kg/m³, the term MDF fiber boards (medium-density fiber boards) is generally used and, if a density of from about 800 to about 1200 kg/m³ is reached, as a rule the term HDF fiber boards (high-density fiber boards) is used.

The production of fiber materials takes place as a rule in a multistage process. As a rule, the fiber is obtained by thermomechanical defibration of woodchips. This is followed by a drying and gluing step, it being possible to effect the gluing before or after the drying. Thereafter, the fiber is sprinkled to give a mat (fiber mat) and shaped into a fiber material in a press under the influence of pressure and temperature. Depending on the shape of the compression mold, sheet-like or multidimensional fiber materials are produced. This can be effected, for example, by preshaping the fiber and then reshaping it in double-belt presses or by means of multidimensional compression molds to give the finished fiber materials. The fiber materials may be used, for example, in the automotive, construction, packaging or furniture industry. The fiber materials can be used here as wall and floor elements for interior finishing, for example as interior cladding or floor laminate, or as a furniture element. Fiber materials having a low density are preferably also used as insulating boards on or in buildings. Another field of use of fiber materials comprises shaped articles which are used, for example, in automotive construction. Motor vehicles are all vehicles which can move forward by means of mechanical power. These are, for example, automobiles, aircraft, railway vehicles or self-propelled construction machines, such as excavators, caterpillars or cranes.

The numerous intended uses can give rise to high requirements with respect to individual quality properties or a plurality of quality properties of the fiber materials. A means for improving the quality properties of fiber materials is the use of binders. Binders which may be used are, for example, synthetic resins, such as diisocyanates or urea-, phenol- or melamine-formaldehyde resins. If formaldehyde-containing binders are used, formaldehyde may be released into the surrounding air and lead to impairment of health, especially in closed rooms. Attempts are therefore made to reduce the proportion of formaldehyde-containing binders in fiber materials or completely to replace formaldehyde-containing binders.

As an alternative to formaldehyde-containing binders, the document EP 1 192 223 B1 presents polyamines and polyamine-containing aminoplast resins as binders for producing fiber boards.

The document DE 43 08 089 A1 describes the use of a composition for producing binders for wood gluing, which comprises a polyamine, a sugar and one or more components from the group consisting of dicarboxylic acid derivatives, aldehydes having two or more carbon atoms and epoxides.

Alternatively, attempts were made to improve the binding effect of substances which usually occur in cellulose-containing plant materials.

Thus, DE 43 05 411 A1 states that oxidases, in particular phenol oxidases, can promote the formation of new lignin linkages in the fiber materials and thus display a binding effect.

In EP 1 184 144 A2, hydrolytic enzymes, such as hemicellulases or cellulases, are used in order to influence the fiber structure of wood fibers positively and to produce fiber materials with or without a reduced proportion of synthetic binders.

Furthermore, hydrolytic enzymes can be used for the preparation of formaldehyde-free binders. Thus, DE 43 40 518 A1 states that, provided it was treated with pectinases, hydrolases or cellulases, potato pulp displays a binding effect in fiber materials.

The wide use of enzymes for producing fiber materials has been unsuccessful to date because of the high costs to which the required amounts of enzyme give rise. The large amount of enzymes also leads as a rule to a higher moisture input during the production of the fiber materials, which in turn necessitates longer and energy-intensive drying of the fiber mats. At the same time, the quality properties of the fiber materials produced using enzymes do not fulfill all standard values prescribed for industrial uses.

Consequently, it was the object to develop a combination of a hydrolytic protein mixture with one or more binders which can be used in amounts which are as small as possible and nevertheless leads to fiber materials having acceptable quality properties. Furthermore, it was the object to improve at least one property of fiber materials, such as the transverse tensile strength, the flexural strength, the flexural modulus of elasticity, the 24 h thickness swelling, the water absorption or the amount of extractable formaldehyde, by the use of hydrolytic protein mixtures in combination with one or more binders or in combination with one or more binders and one or more assistants.

This object could be achieved by the use of hydrolytic protein mixtures in combination with at least one polyamine- or polyimine-containing binder or any desired mixture of these binders. It was found that hydrolytic protein mixtures in combination with one or more polyamine- or polyimine-containing binders or in combination with one or more other binders and one or more assistants not only reduces the required amount of the required hydrolytic protein mixture and the required amount of binder but can also improve the transverse tensile strength or the flexural strength or the flexural modulus of elasticity or the 24 h thickness swelling or the water absorption or the amount of extractable formaldehyde. As a rule, a combination of these properties is improved.

Fiber materials are produced as a rule from fiber. Fiber in turn can be obtained from lignocellulose-containing materials by thermomechanical digestion or by chemical digestion, for example by sulfite, sulfate or organosolv processes or by the steam explosion process according to Mason. The thermomechanical digestion is usually carried out in a defibrator or a refiner. Lignocellulose-containing materials which consist as a rule of woodchips, sawdust or other materials having larger or smaller accumulations of cellulose fibers or lignocellulose are used for the defibrations. Other materials are, for example, waste wood, rape straw, flax, hemp, cereal straw, coconut fibers, bamboo, rice straw or bagasse. They can be used alone or as mixtures. Waste wood is understood here as meaning all wood materials which were already used in the form of structural wood, pieces of furniture, pallets, fiber materials or the like.

In the process according to the invention, the fiber is brought into contact or mixed with one or more hydrolytic protein mixtures, the binder or binders and any assistants required. This can take place individually or in mixtures and at one or more points in time. Preferably, hydrolytic protein mixtures having different properties or compositions are used at different times. The type and amount of binder and assistants required in each case depends on the requirements and quality standards which the fiber material produced has to fulfill. Depending on the conditions, in particular moisture conditions, under which the fiber is treated with the hydrolytic protein mixture, the binder or the binders and the assistant or assistants, a distinction is made between the wet, semidry and dry process. For the dry process, for example, the treated fiber should not exceed a mat moisture of 25% by weight. The mat-moisture is a measure of the moisture content of the fiber and relates to the total weight of the moist fiber. The mat moisture can be determined by means of thermogravimetry, for example using an IR moisture measuring apparatus or by determining the mass difference between moist fiber and the fiber dried to constant mass.

The hydrolytic protein mixtures used in the process according to the invention can be brought into contact with the fiber in various ways, for example by spraying, immersion or impregnation, or can be mixed with the fiber. Because of the smaller amount of liquid, spraying is preferred in the dry process. For the wet or semidry process, the hydrolytic protein mixtures can also be brought into contact with the fiber by means of immersion or impregnation.

The hydrolytic protein mixtures used in the process according to the invention have a xylanase or AZO-CMC activity. Preferably, they have a xylanase activity and an AZO-CMC activity. The xylanase or the AZO-CMC activity or both may be based in each case on the activity of individual enzymes or on different enzymes or isoenzymes of the same or similar activity. These enzymes or isoenzymes may be present in different concentrations in a hydrolytic protein mixture.

Unless stated otherwise, the activities of all enzymes or isoenzymes mentioned in the patent description are determined according to the recommendations of the IUPAC Commission on Biotechnology.

All proteins and enzymes mentioned in the patent description may be of viral, microbial, vegetable or animal origin. In particular, they may be of microbial origin, for example, prokaryotic or fungal origin.

Xylanase activity is caused by xylanases. Xylanases are hemicellulases which can hydrolyze polysaccharides comprising 1,4-beta-glycosidically linked D-xylanopyranoses having short side groups of different composition (so-called xylans). They have a large structural variety and are formed by numerous organisms. Depending on the type of the respective xylanase, they may have endo- or exo-activity or endo- and exo-activity. Xylanases are divided as a rule into three groups which in each case comprise xylanases having predominantly or exclusively endo-1,4-β-D-xylanase or predominantly or exclusively endo-1,3-β-xylanase or predominantly or exclusively xylan-1,4-β-xylosidase activity. The xylanase activity can be supported or synergistically promoted by enzymes which can deacetylate acetylxylan.

Methods for determining the xylanase activity are described, for example, in Pure & Appl. Chem., vol. 59, No. 12, pages 1739-1752. Here, the activity should be in a range from 100 to 30 000 U/ml. Preferably, it is in the range from 10 000 to 21 000 U/ml and particularly preferably in the range from 17 000 to 21 000 U/ml.

The AZO-CMC activity is mainly caused by a subgroup of cellulases. Cellulases are enzymes which can degrade cellulose. Cellulases are divided as a rule into four groups which in each case have enzymes with predominantly or exclusively endo-1,4-β-glucanase, predominantly or exclusively exo-cellobiohydrolase, predominantly or exclusively cellobiase or predominantly or exclusively exo-glucohydrolase activity. The AZO-CMC activity is mainly caused by enzymes having predominantly or exclusively endo-1,4-β-glucanase activity, which are consequently also referred to as endo-cellulases.

The AZO-CMC activity can be determined by means of CM cellulose, in particular CM cellulose 4M, at a pH of 4.5 and a temperature of 40° C. Here, the activity should be in a range from 50 to 700 U/ml. Preferably, it is in the range from 100 to 500 U/ml and particularly preferably in the range from 300 to 450 U/ml.

For determining the activity of hydrolytic protein mixtures, further activities can be determined. Various substrates can be used for this purpose. The activity is determined as a rule in the form of international units (IU). An international unit corresponds to a substrate conversion of 1 μmol per minute. For example, 1 IU filter paper activity (FPA) corresponds to the formation of 1 μmol of glucose, with filter paper as the substrate.

In further embodiments, the hydrolytic protein mixtures comprise further enzymes which can deacetylate acetylxylan or further enzymes having exo-cellobiohydrolase activity or further enzymes having cellobiase activity or further enzymes having phenoloxidase activity, for example laccase activity, or further enzymes having peroxidase activity.

Preferably, the hydrolytic protein mixtures comprise further enzymes for two or more of these activities. In an embodiment, the protein mixtures comprise enzymes for xylanase, AZO-CMC, laccase and peroxidase activity.

Phenoloxidases are enzymes which can convert mono-, oligo- or polyphenols into the corresponding quinones with participation of oxygen. A particularly important group of phenoloxidases comprises laccases; the laccase activity is determined as a rule with syringaldehyde azine or ABTS.

Peroxidases are enzymes which catalyze the oxidation of various substrates with hydrogen peroxide (H₂O₂) as an oxidizing agent. They can be detected by means of the ABTS test.

The hydrolytic protein mixtures used in the process according to the invention may comprise proteins having a binding effect. These are proteins which can bind constituents of plant cell walls, for example lignocellulose, cellulose, hemicellulose or comparable materials or support the binding thereof. Examples of such proteins are lectins, albumins or keratins.

Proteins having a binding effect can alternatively also be added to the fiber before, after or during the use of the hydrolytic protein mixtures.

The hydrolytic protein mixtures used in the process according to the invention are obtained as a rule from microbial culture supernatants. The term culture supernatant comprises all constituents of a microbial culture except for the cultured organism. They are as a rule liquid and can be separated from the cultured organism by methods such as filtration or centrifuging. For obtaining the hydrolytic protein mixtures from the culture supernatants, these can be combined with other culture supernatants or protein fractions, fractionated, purified, concentrated or treated by further customary techniques. Appropriate techniques are known to the person skilled in the art.

Alternatively, the protein mixtures can be obtained completely or partly by the digestion of organisms. These organisms are as a rule of microbial nature but can in principle originate from all organism kingdoms.

The hydrolytic protein mixtures may be completely or partly dissolved in a solvent, present as a solid with a larger or smaller amount of liquid or may be dried. In dried form, the hydrolytic protein mixtures may have been converted into powder, granules or a more or less specific form. Such forms are, for example, tablets or pellets.

In particular, bacterial or fungal organisms whose source of nutrition may be lignocellulose-containing substrates, such as brown or white rot fungi, are suitable as a source of the hydrolytic protein mixtures or of the microbial cultures. Suitable enzymes also occur, for example, in insects, such as the clothes moth, or in molluscs or in prokaryotic or eukaryotic protozoa of the intestinal flora of other organisms, for example of the intestinal flora of insects or ruminants. The term microbial cultures is therefore also intended to comprise cell cultures of vegetable origin or cultures of cells of invertebrate animals. Examples of such cultures are cultures of unicellular or multicellular algae, protozoas, cell cultures of multicellular plants or insect cell cultures.

For example, bacillus, streptomyces or cellumonas genera can be used as bacterial organisms. Examples are: Bacillus subtilis, Bacillus pumilus, Bacillus coagulans, Bacillus stearothermophilus or Streptomyces lividans.

Yeasts, such as Aureobasidium pullulans, Cryptococcus albidus or Trichosporon cutaneum, or filamentous fungi, such as Trichoderma, Trichothetium, Aspergillus or Penicillium genera can be used as fungal organisms. These are, for example, Trichoderma reesei, Trichoderma viride, Trichoderma harzianum, Aspergillus niger, Aspergillus terreus, Aspergillus japonicus, Aspergillus fumigatus, Trichothecium roseum, Thermosascus aurantiacus, Penicillium simplicissimus, Penicillium verruculosum or Penicillium janthinellum.

Trichoderma reesei, Trichoderma harzianum, Trichoderma viride, Aspergillus niger, Aspergillus terreus, Bacillus pumilus, Bacillus coagulans or Bacillus subtilis are preferably used. Trichoderma reesei is particularly preferably used.

Cells or organisms which are used for microbial cultures may originate from strains or varieties occurring in nature, or from cross products, mutants or recombinant forms. The genome of these strains or varieties, cross products, mutants or recombinant forms may occur completely or partly in haploid, diploid or polyploid form.

The hydrolytic protein mixtures used in the process according to the invention originate as a rule from a culture supernatant of a pure microbial culture, i.e. from a microbial culture which comprises only one type of organism. The hydrolytic protein mixtures can, however, also be composed of culture supernatants of mixed cultures, i.e. of cultures of two or more types of organisms or of mixtures of two or more culture supernatants or mixtures of two or more proteins or of protein mixtures of two or more culture supernatants. Culture supernatants are considered as different culture supernatants if they originate from microbiological cultures of organisms of different type. Alternatively, they were obtained from culture supernatants of organisms of the same biological type which differ in the strain or the variety used in each case, the cross product, the mutant or the recombinant form or in the culture conditions used.

The culture conditions include all parameters in which microbial cultures may differ and which have an influence on the composition of the culture supernatant. The composition of the culture medium, the pH, the incubation temperature, the culture duration, the culture density or the change of one or more such parameters and the time sequence of these changes may be mentioned as examples of such parameters.

For the production of the hydrolytic protein mixtures, proteins from different culture supernatants can be mixed before or after their addition to the fiber. This can be effected, for example, by adding hydrolytic protein mixtures from various culture supernatants in liquid or solid form at different times to the fiber.

The incubation conditions and the incubation time can be adapted according to the absolute level of the individual enzymatic activities, the ratio thereof to one another or the type of fiber. The incubation time may be, for example, from a few minutes to a few days. Incubation conditions, such as pH, temperature, concentration of the hydrolytic protein mixture or the concentration of salts, may vary and be adapted to the respective production conditions.

The optimum incubation conditions can be determined via routine experiments. For example, advantageous incubation conditions for hydrolytic protein mixtures comprising Trichoderma reesei are in the range from 20 to 65° C. A temperature in the range from 40 to 55° C. is preferred and one in the range from 45 to 55° C. is particularly preferred. In general, a temperature of 50° C. is preferred. The pH is usually in the range from 3 to 7, preferably in a range from 4.5 to 6.0 and particularly preferably in a range from 4.5 to 5.0.

The hydrolytic protein mixture or the hydrolytic protein mixtures is or are used according to the invention in combination with at least one polyamine-containing or polyimine-containing binder. Polyethylenimine-containing binders are preferred.

The polyamine-containing or polyimine-containing binders may comprise either only polyamines or only polyimines or any desired mixture of these. The proportion of the polyamines or of the polyimines may be up to 100% by weight, based on the total weight of the polyamine-containing or polyimine-containing binders.

The polyamine-containing or polyimine-containing binders may comprise amide, amine, acid, ester, halogen, acetal, hemiacetal, aminal, hemiaminal, carbamate or imine groups or a mixture of these. Preferably, they comprise amine, amide, ester or acetal groups or a mixture of at least two of these groups. Particularly preferably, they comprise only amine groups.

Among the polyimines, polyethylenimines are preferred.

Polyethylenimines are polymers of ethylenimine which are prepared by polymerization of ethylenimine in an aqueous medium in the presence of small amounts of acids or acid-forming compounds, such as halogenated hydrocarbons, e.g. chloroform, carbon tetrachloride, tetrachloroethane or ethyl chloride, or are condensates of epichlorohydrin and compounds comprising amino groups, such as mono- or polyamines, e.g. dimethylamine, diethylamine, ethylenediamine, diethylenetriamine and triethylenetetramine or ammonia.

This group of cationic polymers also includes graft polymers of ethylenimine on compounds which have a primary or secondary amino group, e.g. polyamidoamines obtained from dicarboxylic acids and polyamines. The polyamidoamines grafted with ethylenimine can, if appropriate, also be reacted with bifunctional crosslinking agents, for example with epichlorohydrin or bischlorohydrin ethers of polyalkylene glycols.

Water-soluble, crosslinked, partly amidated polyethylenimines are disclosed in WO-A-94/12560. They are obtainable by reacting polyethylenimines with monobasic carboxylic acids or their esters, anhydrides, acid chlorides or acid amides with amide formation and reaction of the amidated polyethylenimines with crosslinking agents comprising at least two functional groups.

The average molar masses M_{w} of the suitable polyethylenimines usually have a broad molar mass distribution and an average molar mass (M_{w}) of, for example, from 129 to 2 million g/mol, preferably from 430 to 1 million g/mol, particularly preferably in a range from 1000 to 500 000 g/mol. In another embodiment, they are in a range from 800 to 100 000 g/mol. The molar mass can be determined by light scattering.

The polyethylenimines are partly amidated with monobasic carboxylic acids so that, for example, from 0.1 to 90, preferably from 1 to 50, % of the amidatable nitrogen atoms in the polyethylenimines are present as amide groups. Suitable crosslinking agents comprising at least two functional double bonds are epichlorohydrin or bischlorohydrin ethers of polyalkylene glycols. Halogen-free crosslinking agents are preferably used.

The polyethylenimines may be quaternized polyethylenimines. For example, both homopolymers of ethylenimine and polymers which comprise, for example, grafted-on ethylenimine (aziridine) are suitable for this purpose. The homopolymers are prepared, for example, by polymerization of ethylenimine in an aqueous solution in the presence of acids, Lewis acids or alkylating agents, such as methyl chloride, ethyl chloride, propyl chloride, ethylene chloride, chloroform or tetrachloroethylene.

Quaternization of the polyethylenimines can be carried out, for example, with alkyl halides, such as methyl chloride, ethyl chloride, hexyl chloride, benzyl chloride or lauryl chloride, and with, for example, dimethyl sulfate.

Further suitable polyethylenimines are polyethylenimines modified by a Strecker reaction, for example the reaction products of polyethylenimines with formaldehyde and sodium cyanide with hydrolysis of the resulting nitriles to give the corresponding carboxylic acids. These products can, if appropriate, be reacted with a crosslinking agent comprising at least two functional groups (see above).

In addition, phosphonomethylated polyethylenimines and alkoxylated polyethylenimines, which, for example, are obtainable by reacting polyethylenimine with ethylene oxide and/or propylene oxide and are described in WO 97/25367, are suitable. The phosphonomethylated and the alkoxylated polyethylenimines can, if appropriate, be reacted with a crosslinking agent comprising at least two functional groups (see above).

Polyamine-containing binders preferably comprise an aliphatic polyamine which has at least three functional groups, selected from the group consisting of the primary and secondary amino groups, and which, apart from tertiary amino groups, is substantially free of other functional groups.

Polyamines can be prepared from polyvinylamides.

Polyvinylamides are known, cf. U.S. Pat. No. 4,421,602, U.S. Pat. No. 5,334,287, EP-A-0 216 387, U.S. Pat. No. 5,981,689, WO-A-00/63295, U.S. Pat. No. 6,121,409 and U.S. Pat. No. 6,132,558. They are prepared by hydrolysis of open-chained polymers comprising N-vinylcarboxamide units. These polymers are obtainable, for example, by polymerization of N-vinylformamide, N-vinyl-N-methylformamide, N-vinylacetamide, N-vinyl-N-methylacetamide, N-vinyl-N-ethylacetamide and N-vinylpropionamide. Said monomers can be polymerized either alone or together with other monomers. N-Vinylformamide is preferred.

In order to prepare polyvinylamines, it is preferable to start from homopolymers of N-vinylformamide or from copolymers which are obtainable by copolymerization of N-vinylformamide with vinyl formate, vinyl acetate, vinyl propionate, acrylonitrile, methyl acrylate, ethyl acrylate and/or methyl methacrylate and subsequent hydrolysis of the homopolymers or of the copolymers with formation of vinylamine units from the N-vinylformamide units incorporated in the form of polymerized units, the degree of hydrolysis being, for example, from 1 to 100 mol %, preferably from 25 to 100 mol %, particularly preferably from 50 to 100 mol % and especially preferably from 70 to 100 mol %.

The hydrolysis of the polymers described above is effected by known processes by the action of acids (e.g. mineral acids, such as sulfuric acid, hydrochloric acid or phosphoric acid, carboxylic acids, such as formic acid or acetic acid, or sulfonic acids or phosphonic acids), bases or enzymes, as described, for example, in DE-A 31 28 478 and U.S. Pat. No. 6,132,558. With the use of acids as hydrolysis agents, the vinylamine units of the polymers are present as the ammonium salt while the free amino groups form during the hydrolysis with bases.

The degree of hydrolysis of the homopolymers is equivalent to the content of vinylamine units in the polymers. In the case of copolymers which comprise vinyl esters incorporated in the form of polymerized units, a hydrolysis of the ester groups with formation of vinyl alcohol units can occur in addition to the hydrolysis of the N-vinylformamide units. This is the case in particular when the hydrolysis of the copolymers is carried out in the presence of sodium hydroxide solution. Acrylonitrile incorporated in the form of polymerized units is likewise chemically changed in the hydrolysis. Here, for example, amide groups or carboxyl groups form. The homo- and copolymers comprising vinylamine units can, if appropriate, comprise up to 20 mol % of amidine units which form, for example, by reaction of formic acid with two neighboring amino groups or intramolecular reaction of an amino group with a neighboring amide group, for example of N-vinylformamide incorporated in the form of polymerized units.

The average molar masses M_{w} of the polymers comprising vinylamine units are, for example, from 500 to 10 million, preferably from 750 to 5 million and particularly preferably from 1000 to 2 million g/mol (determined by light scattering). In alternative embodiments, the average molar masses are from 5000 to 200 000 g/mol or from 600 to 1 million g/mol. This molar mass range corresponds, for example, to K values of from 30 to 150, preferably from 60 to 100 (determined according to H. Fikentscher in 5% strength aqueous sodium chloride solution at 25° C., a pH of 7 and a polymer concentration of 0.5% by weight).

The polymers comprising vinylamine units have, for example, a charge density (determined at pH 7) of from 0 to 18 meq/g, preferably from 5 to 18 meq/g and in particular from 10 to 16 meq/g.

The polymers comprising vinylamine units are preferably used in salt-free form. Salt-free aqueous solutions of polymers comprising vinylamine units can be prepared, for example, from the salt-containing polymer solutions described above with the aid of ultrafiltration over suitable membranes at cut-offs of, for example, from 1000 to 500 000 dalton, preferably from 10 000 to 300 000 dalton.

Suitable comonomers are monoethylenically unsaturated monomers. Examples of these are vinyl esters of saturated carboxylic acids of 1 to 6 carbon atoms, such as vinyl formate, vinyl acetate, N-vinylpyrrolidone, vinyl propionate and vinyl butyrate, and vinyl ethers, such as C1- to C6-alkyl vinyl ethers, e.g. methyl or ethyl vinyl ether. Further suitable comonomers are esters of alcohols having, for example, 1 to 6 carbon atoms, amides and nitriles of ethylenically unsaturated C3- to C6-carboxylic acids, for example methyl acrylate, methyl methacrylate, ethyl acrylate, ethyl methacrylate and dimethyl maleate, acrylamide and methacrylamide and acrylonitrile and methacrylonitrile.

Further suitable comonomers are derived from glycols or polyalkylene glycols, in each case only one OH group being esterified, e.g. hydroxyethyl acrylate, hydroxyethyl methacrylate, hydroxypropyl acrylate, hydroxybutyl acrylate, hydroxypropyl methacrylate, hydroxybutyl methacrylate and acrylic acid monoesters of polyalkylene glycols having a molar mass of from 500 to 10 000. Further suitable comonomers are esters of ethylenically unsaturated carboxylic acids with aminoalcohols, such as, for example, dimethylaminoethyl acrylate, dimethylaminoethyl methacrylate, diethylaminoethyl acrylate, diethylaminoethyl methacrylate, dimethylaminopropyl acrylate, dimethylaminopropyl methacrylate, diethylaminopropyl acrylate, dimethylaminobutyl acrylate and diethylaminobutyl acrylate. The basic acrylates can be used in the form of the free bases, of the salts with mineral acids, such as hydrochloric acid, sulfuric acid or nitric acid, of the salts with organic acids, such as formic acid, acetic acid, propionic acid, or of the sulfonic acids or in quaternized form. Suitable quaternizing agents are, for example, dim ethyl sulfate, diethyl sulfate, methyl chloride, ethyl chloride or benzyl chloride.

Further suitable comonomers are amides of ethylenically unsaturated carboxylic acids, such as acrylamide, methacrylamide and N-alkylmono- and diamides of monoethylenically unsaturated carboxylic acids having alkyl radicals of 1 to 6 carbon atoms, e.g. N-methylacrylamide, N,N-dimethylacrylamide, N-methylmethacrylamide, N-ethylacrylamide, N-propylacrylamide and tert-butylacrylamide, and basic (meth)acrylamides, such as, for example, dimethylaminoethylacrylamide, dimethylaminoethylmethacrylamide, diethylaminoethylacrylamide, diethylaminoethylmethacrylamide, dimethylaminopropylacrylamide, diethylaminopropylacrylamide, dimethylaminopropylmethacrylamide and diethylaminopropylmethacrylamide.

Furthermore, the following are suitable as comonomers: N-vinylcaprolactam, acrylonitrile, methacrylonitrile, N-vinylimidazole and substituted N-vinylimidazoles, such as, for example, N-vinyl-2-methylimidazole, N-vinyl-4-methylimidazole, N-vinyl-5-methylimidazole, N-vinyl-2-ethylimidazole, and N-vinylimidazolines, such as N-vinylimidazoline, N-vinyl-2-methylimidazoline and N-vinyl-2-ethylimidazoline. N-Vinylimidazoles and N-vinylimidazolines are used not only in the form of the free bases but also in a form neutralized with mineral acids or organic acids or in quaternized form, the quaternization preferably being carried out with dimethyl sulfate, diethyl sulfate, methyl chloride or benzyl chloride. Diallyldialkylammonium halides, such as, for example, diallyldimethylammonium chloride, are also suitable.

The polymerization of the monomers is usually carried out in the presence of free radical polymerization initiators. The homo- and copolymers can be obtained by all known processes; for example, they are obtained by solution polymerization in water, alcohols, ethers or dimethylformamide or in mixtures of different solvents, by precipitation polymerization, inverse suspension polymerization (polymerization of an emulsion of a monomer-containing aqueous phase in an oil phase) and polymerization of a water-in-water emulsion, for example in which an aqueous monomer solution is dissolved or emulsified in an aqueous phase and polymerized with formation of an aqueous dispersion of a water-soluble polymer, as described, for example, in WO 00/27893. After the polymerization, the homo- and copolymers which comprise N-vinylcarboxamide units incorporated in the form of polymerized units are partly or completely hydrolyzed, as described.

Derivatives of polymers comprising vinylamine units can also be used as polyamine-containing binders. Thus, it is possible, for example, to obtain a multiplicity of suitable derivatives from the polymers comprising vinylamine units by amidation, alkylation, sulfonamide formation, urea formation, thiourea formation, carbamate formation, acylation, carboxymethylation, phosphonomethylation or Michael addition of the amino groups of the polymer. Of particular interest here are uncrosslinked polyvinylguanidines which are obtainable by reacting polymers comprising vinylamine units, preferably polyvinylamines, with cyanamide (R1R2N—CN, where R1, R2 are H, C1- to C4-alkyl, C3- to C6-cycloalkyl, phenyl, benzyl, alkyl-substituted phenyl or naphthyl), cf. U.S. Pat. No. 6,087,448, column 3, line 64 to column 5, line 14.

The polymers comprising vinylamine units also include hydrolyzed graft polymers of, for example, N-vinylformamide on polyalkylene glycols, polyvinyl acetate, polyvinyl alcohol, polyvinylformamides, polysaccharides, such as starch, oligosaccharides or monosaccharides. The graft polymers are obtainable by subjecting, for example, N-vinylformamide to a free radical polymerization in an aqueous medium in the presence of at least one of said grafting bases, if appropriate together with copolymerizable other monomers, and then hydrolyzing the grafted-on vinylformamide units in a known manner to give vinylamine units.

The combinations of hydrolytic protein mixtures and polyamine-containing or polyimine-containing binders can be combined with one or more other binders. According to a preferred embodiment, polyamine-containing or polyimine-containing binders are used alone.

Other possible binders may be: urea, phenol or melamine-urea-formaldehyde resins or alkyd, epoxy, unsaturated polyester, polyurethane, ketone, isocyanate, polyamide, polyester or diisocyanate resins.

For example, urea-formaldehyde resins and melamine-urea-formaldehyde resins are advantageous. Urea-formaldehyde resins are preferred, for example those which are sold under the trade names of BASF Aktiengesellschaft, such as Kaurit® 347, Kaurit® 403 or Kauramin® 620. Among the melamine-urea-formaldehyde resins, those having more than 20% by weight of melamine, based on the total weight of the melamine-urea-formaldehyde resin, are preferred.

If urea, phenol or melamine-urea-formaldehyde resins are used in combination with hydrolytic protein mixtures, a combination of from 3 to 15% by weight of binder and from 0.1 to 10% by weight of hydrolytic protein mixture is advantageous. A combination of from 5 to 12% by weight of binder and from 0.1 to 5% by weight of hydrolytic protein mixture is preferred. A combination of from 5 to 8% by weight of binder and from 0.3 to 3% by weight of hydrolytic protein mixture is particularly preferred.

If polyamine-containing or polyimine-containing binders are used in combination with hydrolytic protein mixtures, a combination of from 0.3 to 10% by weight of polyamine-containing or polyimine-containing binder and from 0.1 to 10% by weight of hydrolytic protein mixture is advantageous, a combination of from 0.5 to 6% by weight of polyamine-containing or polyimine-containing binder and from 0.1 to 5% by weight of hydrolytic protein mixture is preferred. A combination of from 0.8 to 4% by weight of polyamine-containing or polyimine-containing binder and from 0.3 to 3% by weight of hydrolytic protein mixture is particularly preferred.

In addition to the binders mentioned, sugars, dicarboxylic acid derivatives, aldehydes having two or more carbon atoms or epoxides or mixtures of these may be used. This can be effected by adding to the fiber one or more sugars, one or more dicarboxylic acid derivatives or one or more aldehydes having two or more carbon atoms or one or more epoxides individually or as a mixture with the binders.

Sugars used may be both monosaccharides and di- or polysaccharides. Examples of such sugars are: hydrolysis products of starch, sucrose or glucose.

Suitable dicarboxylic acid derivatives are dicarboxylic acid derivatives of alkyl- or aryldicarboxylic acids. The term dicarboxylic acid derivatives is to be understood as meaning both the free dicarboxylic acids and the corresponding anhydrides or esters. Suitable dicarboxylic acids are, for example, maleic acid, fumaric acid, phthalic acid and glutaric acid. Succinic anhydride, maleic anhydride and phthalic anhydride are advantageous.

Among the aldehydes having two or more carbon atoms, aldehydes having two to six carbon atoms are preferred. Preferred aldehydes having two or more carbon atoms are propanal, butanal, pentanal and very particularly preferably 2-methoxyacetaldehyde.

Suitable epoxides are in particular epoxides having two to ten carbon atoms. These are in particular propylene oxide, isobutene oxide, butene oxide, cyclohexene oxide and styrene oxide.

The use of the sugars, dicarboxylic acid derivatives, aldehydes having two or more carbon atoms or epoxides is known to the person skilled in the art. Further information is to be found in DE 43 08 089 A1.

The binder or the binders is or are used in the process according to the invention as a rule in an amount from 3 to 20% by weight, based on the total weight of the respective fiber material and measured as the total weight of all the binders used. The required amount of the binder depends to a great extent on the type of binder or the combination of binder and other binders. For example, polyvinylamines or polyethylenimines are usually used in a range from 0.05 to 5% by weight and preferably in a range from 0.1 to 2% by weight, based on the total weight of the respective fiber.

Depending on the binder or combination of binder and other binders used and on the desired quality properties of the fiber materials, the amounts used can, however, also differ from the stated amounts.

In the production, according to the invention, of the fiber materials, assistants can be added to the fiber. All substances which are not binders, hydrolytic protein mixtures or fiber and which improve the properties, in particular quality properties, of the fiber materials, relative to the respective intended use of the fiber material, are designated as assistants.

For example, assistants may be: water repellants, salts, waterglass, biocides, dyes, fireproofing agents, surfactants, stabilizers or formaldehyde scavengers.

For example, paraffin waxes, paraffin emulsions, oils or silicones can be used as water repellants. Paraffin waxes or paraffin emulsions are preferred and paraffin emulsions are particularly preferred.

Typically used biocides are fungicides or insecticides. Examples of biocides are sodium benzoate, boron, fluorine and arsenic compounds, copper salts, quaternary ammonium compounds or chromates. Formaldehyde likewise has a biocidal action and could therefore in this function

Further assistants and the advantageous amounts of the respective assistant are known to the person skilled in the art. Further information can be found by the person skilled in the art in DIN 68800-3 or in M. Dunky, P. Niemz, Holzwerkstoffe and Leime, Springer Verlag, 2002, for example on pages 330 to 321, page 367 or pages 436 to 444.

As a rule, paraffin is used in a proportion of from 0.01 to 3% by weight, based on the total weight of the fiber material. It is preferably used in a proportion of from 0.1 to 2% by weight. It is particularly preferably used in a proportion of from 0.3 to 1.5% by weight, most preferably in a proportion of from 0.5 to 1% by weight. In one embodiment, it is used in a proportion of 1% by weight, based in each case on the total weight of the fiber.

The assistants can be added together or separately from the binders or the hydrolytic protein mixture or mixtures or from all of these. The preferred procedure is dependent on the type of assistant and on the process used for the production of the fiber materials and is known to the person skilled in the art. The person skilled in the art can find information in DIN 68800-3 or in M. Dunky, P. Niemz, Holzwerkstoffe und Leime, Springer Verlag, 2002, for example on pages 436 to 444.

For example, paraffin can be added together with or separately from one or more binders. In a preferred embodiment, paraffin is added separately from the binder or the binders.

The fiber brought into contact or mixed with the hydrolytic protein mixture, the binder or the binders and any assistants required is dried prior to pressing in pneumatic or belt dryers at temperatures of from 30 to 150° C., preferably from 40 to 90° C. and pressed under the influence of heat and pressure. If the enzymatic activities of the hydrolytic protein mixtures are to be retained during the drying process, it should be ensured that the temperatures used do not lead to deactivation of the respective enzymes. Particularly in this case, dry gluing is therefore preferred to blow-line gluing. In another embodiment, the hydrolytic protein mixture is applied in combination with the binder or the binders and/or any assistants required to the fiber after the drying process.

The respective maximum temperature depends on the type of enzymes present in the hydrolytic protein mixtures. The maximum usable temperature should not lead to any deactivation or only to slight deactivation of the enzymatic activity. If high temperatures are used, hydrolytic protein mixtures having a high optimum temperature should be used. These are as a rule to be found in thermophilic or hyperthermophilic organisms. An example of such an organism is Pyrococcus horikoshii.

In principle, all methods which are suitable for destroying or temporarily suppressing enzymatic activity are suitable for terminating the incubation time; these are, for example, heat deactivation, addition of inhibitors or a change in the pH. The preferred method depends on the properties of the hydrolytic protein mixture used and on the production conditions.

Hot pressing can be effected by the customary methods. These methods are known to the person skilled in the art. Further information is to be found, for example, in M. Dunky, P. Niemz, Holzwerkstoffe und Leime, Springer Verlag, 2002, pages 91 to 158.

The density of the fiber materials produced may be in the range from 100 to 1200 kg/m³. MDF boards or moldings preferably have a density of from 650 to 900 kg/m³, while insulating boards preferably have a density in the range from 200 to 400 kg/m³.

Since fiber materials are used for numerous purposes, they must be able to meet numerous quality requirements. The quality of fiber materials is therefore determined by means of various methods of measurement which in each case describe different quality properties of the fiber materials. Such quality properties are, for example, the water vapor permeability according to DIN EN ISO 12572, the delamination resistance of the surface according to DIN EN 311, the shear strength parallel to the plane of the board according to DIN 52371, the tensile strength perpendicular to the plane of the board according to DIN EN 319, the resistance to the axial withdrawal of screws according to DIN EN 320, the moisture content according to DIN 52351, the water absorption according to DIN EN 317, the flexural strength according to DIN EN 310, the flexural modulus of elasticity according to DIN EN 310, the 24 h thickness swelling according to DIN EN 317, the transverse tensile strength according to DIN EN 319 and the amount of extractable formaldehyde according to DIN EN 120.

By means of the process according to the invention, various quality properties of the fiber materials can be tailored to the intended use.

Preferably, one or more of the following quality properties are improved: the water absorption according to DIN EN 317, the flexural strength according to DIN EN 310, the flexural modulus of elasticity according to DIN EN 310, the 24 h thickness swelling according to DIN EN 317, the transverse tensile strength according to DIN EN 319 and the amount of extractable formaldehyde according to DIN EN 120. The transverse tensile strength according to DIN EN 319 is very particularly preferably improved.

The invention is illustrated with reference to the following, nonlimiting, examples.

### EXAMPLES

Unless stated otherwise, the quality properties of the fiber materials produced in the examples were determined by the abovementioned standard methods.

The stated percentages by weight are based on the total weight of the fiber in the absolutely dry state (ADRY), unless stated otherwise.
Unless stated otherwise, a hydrolytic protein mixture produced by Novozym and obtained from a microbial culture of Trichoderma reesei having the following properties was used:
334 g/l protein content,
355.8 U/ml AZO-CMC activity,
13 404 IU/ml xylanase activity

### Example 1

### Combination of Hydrolytic Protein Mixtures with Polyethylenimine Binders

A fiber was used for producing fiber material. This fiber was produced from pinewood chips which were defibrated at 170° C. and with a refiner gap of 0.2 mm. The fiber moisture after intermediate drying in a pneumatic dryer was 3.3% by weight based on the total mass of the fiber. Depending on the experimental variant, varying types of binders and hydrolytic protein mixtures were added to this fiber. In experimental variants 6 to 8, the hydrolytic protein mixtures and the binder were first mixed and only thereafter added to the fiber.

The polyethylenimine used consisted of a cationic, dendritically branched, unmodified homopolymer having a molar mass (M_{w}), measured by means of light scattering, of 5000:

U/ml means units/ml and IU/ml means international units/ml, determined in each case according to the IUPAC rules for determining the respective enzyme activity.

| | Proportion | |
|---|---|---|
| | of hydrolytic | Proportion of the binder |
| | protein mixture | polyethylenimine |
| Experimental variant | [% by weight] | [% by weight] |
| 1 | | |
| 2 | | 1 |
| 3 | | 3 |
| 4 | | 4 |
| 5 | 0.5 | 1 |
| 6^{a)} | 0.5 | 1 |
| 7^{a)} | 1 | 2 |
| 8^{a)} | 1 | 2 |

^{a)}Premix of hydrolytic protein mixture and binder

The data in % by weight are based on the total weight of the fiber in the absolutely dry state. The mixing with the fiber was effected in each variant by means of a gluing drum in the drying process. For adjusting fiber moisture, these were provided with about 8% by weight of buffer. After mixing was complete, the fiber was sprinkled by hand to give a mat. In all variants, the mat moisture was from 8 to 10% by weight, based on the total mass of the mat. The mat was transferred to a hot press and pressed to give thin fiber materials having a thickness of 4 mm and dimensions of 20×20 cm. The hot pressing was effected at a temperature of 180° C. and for a pressing time of 90 seconds (22 seconds per mm). After the hot pressing, the boards were conditioned for 24 hours.

| | Experimental variant | | | | | | | |
|---|---|---|---|---|---|---|---|---|
| | 1 | 2 | 3 | 4 | 5 | 6 | 7 | 8 |
| Flexural strength | 19 | 24.7 | 34.2 | 38 | 24.5 | 28.5 | 33.2 | 39 |
| [N/mm²] | | | | | | | | |
| Flexural modulus | 2497 | 2731 | 3046 | 3315 | 2600 | 3065 | 2963 | 3309 |
| of elasticity | | | | | | | | |
| [N/mm²] | | | | | | | | |
| Transverse tensile | 0.17 | 0.38 | 0.59 | 0.6 | 0.44 | 0.40 | 0.76 | 0.9 |
| strength | | | | | | | | |
| [N/mm²] | | | | | | | | |
| 24 h thickness | 496 | 89 | 60 | 57 | 98 | 85 | 68 | 67 |
| swelling | | | | | | | | |
| [%] | | | | | | | | |

### Example 2

### Comparison of Different Combinations of Binder and Hydrolytic Protein Mixture

Sprucewood fiber which had been equilibrated for 24 hours at 25° C. and 65% relative humidity was used as starting material. 1000 g of this fiber were flushed with gaseous nitrogen. After one minute, depending on the experimental variant, binder or hydrolytic protein mixture or both were introduced at a constant flow rate of 20 ml/minute. The hydrolytic protein mixture used had a protein content of 71.4 g/l, an AZO-CMC activity of 141.62 U/ml, a filter paper activity of 29.21 IU/ml, a xylanase activity of 2032.84 IU/ml and a content of reduced sugar of 9.84 g/l.

The hydrolytic protein mixture was introduced first in each case. Thereafter, after a reaction time of a further ten minutes, the binder used in each case was added. After a subsequent mixing time of one minute, the mixture present was incubated for a further hour. Thereafter, the mixture was introduced into a technical hot press measuring 30×30 cm and shaped at a temperature of 180° C. and in a time of 60 seconds and with a force of 10 kN. This resulted in fiber materials having a thickness of 4.0 mm and a density of 800 kg/m³. The fiber materials were stored for 16 hours at room temperature before their quality properties were measured.

The quality properties were determined according to the respective DIN standard.

| | | Protein | Transverse | 24 h | | |
|---|---|---|---|---|---|---|
| | Binder | mixture | tensile | thickness | Extractable | Water |
| Experimental | [% by | [% by | strength | swelling | formaldehyde | absorption |
| variant | weight] | weight] | [N/mm²] | [%] | [0.1 mg/100 g] | [%] |
| 1 | 12% by | | 1.61 | 21.9 | 69 | 71.2 |
| | weight of | | | | | |
| | Kaurit ® 347 | | | | | |
| 2 | 1.5% by | | 0.37 | 91.7 | | 160.7 |
| | weight of | | | | | |
| | polyvinyl- | | | | | |
| | amine | | | | | |
| 3 | | 0.5 | 0.68 | 70.8 | | 144.5 |
| 4 | 6% by | 0.5 | 1.28 | 33.2 | 61 | 84.1 |
| | weight of | | | | | |
| | Kaurit ® 347 | | | | | |
| 5 | 6% by | | 0.86 | 35 | 94 | 92.9 |
| | weight of | | | | | |
| | Kaurit ® 347 | | | | | |
| 6 | 3% by | 0.5 | 0.91 | 47 | 78 | 103.2 |
| | weight of | | | | | |
| | Kaurit ® 347 | | | | | |
| 7 | 2.5% by | 0.5 | 0.94 | 47.7 | | 113.6 |
| | weight of | | | | | |
| | polyvinyl- | | | | | |
| | amine | | | | | |

The polyvinylamine used was prepared from vinylformamide and had a degree of hydrolysis of 95 and a K value of 45. The K value was determined according to H. Fikentscher in 5% strength aqueous sodium chloride solution at 25° C., a pH of 7 and a polymer concentration of 0.5% by weight.

1.-10. (canceled)

11. A process for producing fiber materials, wherein at least one hydrolytic protein mixture and at least one polyamine- or polyimine-containing binder or any mixture of these binders are used for producing the fiber materials.

12. The process according to claim 11, wherein at least one hydrolytic protein mixture has xylanase or AZO-CMC activity or both activities.

13. The process according to claim 11, wherein at least one hydrolytic protein mixture comprises further enzymes or proteins having a binding effect or is used in combination with these.

14. The process according to claim 11, wherein at least one other binder is additionally used.

15. The process according to claim 11, which further comprises at least one assistant.

16. The process according to claim 15, wherein at least one assistant is a water repellant.

17. The process according to claim 11, wherein the fiber materials are produced by means of dry gluing.

18. The use of at least one hydrolytic protein mixture according to claim 11 and at least one polyamine binder or at least one polyimine binder or at least one polyamine-containing or polyimine-containing binder or any mixture of these binders alone or in combination with at least one other binder or at least one assistant or at least one other binder and at least one assistant for producing fiber materials.

19. A fiber material obtainable by the process according to claim 11.

20. The fiber material according to claim 19 for the automotive, construction, packaging or furniture industry.
